(19) United States
(12) Patent Application Publication
(10) Pub. No.: US 2013/0290601 A1
(43) Pub. Date: Oct. 31, 2013

(54) LINUX I/O SCHEDULER FOR SOLID-STATE DRIVES

(71) Applicants: Kunal Sablok, Bangalore (IN); Siddhartha Kumar Panda, Bangalore (IN)

(72) Inventors: Kunal Sablok, Bangalore (IN); Siddhartha Kumar Panda, Bangalore (IN)

(73) Assignee: LSI CORPORATION, Milpitas, CA (US)

(21) Appl. No.: 13/456,338

(22) Filed: Apr. 26, 2012

(51) Int. Cl. G06F 12/02

(52) U.S. Cl. 711/103; 711/E12.008

(57) ABSTRACT

An I/O scheduler and a method for scheduling I/O requests to a solid-state drive (SSD) is disclosed. The I/O scheduler in accordance with the present disclosure bundles the write requests in such a form that the write requests in each bundle goes into one SSD block. Bundling the write requests in accordance with the present disclosure reduces write amplification and increases system performance. The I/O scheduler in accordance with the present disclosure also helps increasing the life of the SSDs.

### TECHNICAL FIELD

The present invention relates to the field of data processing and particularly to an input/output (I/O) scheduler for solid-state drives.

### BACKGROUND

Hard disks are commonly used as storage devices for storing and retrieving data. The factors that limit the time to access the data on a hard disk are mostly related to the mechanical nature of the rotating disks and moving heads. Seek time is a measure of how long it takes the head assembly to travel to the track of the disk that contains data. This time affects system performance. In addition, hard disks require more power consumptions. Solid-state drives (SSDs) do not have the drawbacks described above. That is, SSDs consume lesser power and requires no disk seek time, therefore providing better performance for I/O requests.

SSD devices have begun to attract a lot of attention. I/O schedulers work in block layer of Linux kernel and are responsible of merging and dispatching of I/O requests in intelligent fashion so as to improve performance of applications. In the latest Linux kernels, I/O schedulers are written keeping in mind the rotational hard drives basically to reduce head movement or seek time. SSD devices have different attributes altogether than traditional hard drivers, so the Linux I/O schedulers are not optimal for SSD devices.

For instance, the 2.6 Linux kernel includes selectable I/O schedulers. There are currently 4 available schedulers, including No-op Scheduler, Anticipatory I/O Scheduler (AS), Deadline Scheduler and Complete Fair Queueing Scheduler (CFQ). All of these schedulers are written for rotational devices. These four algorithms normally perform two kinds of operations, i.e., sorting and merging of requests. Such operations are required to reduce the disk head movement. Since hard disks take the input sectors and process them in circular order, I/O scheduler algorithms try to sort the requests and disk head movement is reduced. However, such schedulers are not optimized for SSDs, as there is no disk head movement for accessing SSDs. For this and other SSD features, the currently available Linux I/O schedulers are not suitable for SSDs.

Therein lies the need to provide an I/O scheduler optimized for solid-state drives.

### SUMMARY

Accordingly, an embodiment of the present disclosure is directed to a method for scheduling write requests to a solid-state drive (SSD). The method may include receiving a plurality of write requests; forming a write bundle, the write bundle including at least one write request of the plurality of write requests, each of the at least one write request in the write bundle is directed to a same flash erasable block of the SSD, and a combined data size of the at least one write request in the write bundle is less than or equal to the flash erasable block size; and dispatching the write bundle to the SSD.

A further embodiment of the present disclosure is directed to a method for scheduling I/O requests to a SSD. The method may include receiving a plurality of I/O requests, the plurality of I/O requests including a plurality of write requests and a plurality of read requests; arranging the plurality of write requests in a write queue, the write queue having at least one write bundle, each particular write bundle of the at least one write bundle including at least one write request of the plurality of write requests, each of the at least one write request in the particular write bundle is directed to a same flash erasable block of the SSD, and a combined data size of the at least one write request in the particular write bundle is less than or equal to the flash erasable block size; arranging the plurality of read requests in a red-black (RB) tree and a first-in first-out (FIFO) queue; and dispatching a write bundle from the write queue for every predetermined number of read requests dispatched.

An additional embodiment of the present disclosure is directed to a computer-readable device having computer-executable instructions for performing a method for scheduling I/O requests to a SSD. The method may include receiving a plurality of I/O requests, the plurality of I/O requests including a plurality of write requests and a plurality of read requests; arranging the plurality of write requests in a write queue, the write queue having at least one write bundle, each particular write bundle of the at least one write bundle including at least one write request of the plurality of write requests, each of the at least one write request in the particular write bundle is directed to a same flash erasable block of the SSD, and a combined data size of the at least one write request in the particular write bundle is equal to the flash erasable block size; arranging the plurality of read requests in a red-black (RB) tree and a first-in first-out (FIFO) queue; and dispatching a write bundle from the write queue for every predetermined number of read requests dispatched.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustrating a Linux I/O scheduler;

FIG. 2 is an illustration depicting merging of I/O requests in a Linux system;

FIG. 3 is an illustration depicting a write queue having a plurality of write bundles in accordance with the present disclosure;

FIG. 4 is an illustration depicting a read queue in accordance with the present disclosure;

FIG. 5 is a flow diagram illustrating a method for scheduling I/O requests to a solid-state drive in accordance with the present disclosure;

FIG. 6 is a chart depicting the IOPS (I/O Operations Per Second) comparison between various schedulers; and

FIG. 7 is a chart depicting the latency comparison between various schedulers.

### DETAILED DESCRIPTION

Reference will now be made in detail to the presently preferred embodiments of the invention, examples of which are illustrated in the accompanying drawings.

A solid-state drive (SSD) is divided into multiple blocks. Each block is of a certain size (e.g., 256 KB). Each block is further divided into multiple pages (e.g., 4 KB), which is the minimum storage unit of the SSD. Each page has two possible states, i.e., erased (free) or trimmed. Initially, all the pages are in erased state. When a fresh write request comes on a page, an erased page is allocated for it. However, over-writing is not allowed because of SSD architecture, thus when a write request comes on the same page again, a new erased page is allocated for write and the old page is marked trimmed. This way, as time passes, random writes make a lot of trimmed pages. When the number of erased pages becomes less than a certain threshold, garbage collection may be triggered which collects various trimmed pages and convert them into erased pages. This collection or erasing process is done per block, i.e., writes happen on pages and erases happen on blocks. Upon completion of the garbage collection, a full block is available for writes. In addition, the mapping between the logical and physical block is done by the FTL layer, which may also perform garbage collection and may be responsible for other SSD features like wear leveling.

The handling of write requests SSDs as described above may cause write amplification. That is, because blocks must be erased before it can be rewritten, the process to perform these operations may result in moving (or rewriting) data more than once. FTL layer also does garbage collection and is responsible for other SSD features like wear leveling. Random writes cause a lot of trimmed pages which reduce the write performance because one host write can imply multiple firmware writes because of garbage collection. The ratio of the number of actual writes by number of host writes at any particular time is called WA (Write Amplification). Large WA means more extra writes are there which increases I/O latency and reduces performance as well as the life of the SSD.

While the traditional I/O schedulers may be utilized with SSD devices, they are not optimized for such devices. For instance, Linux kernel 2.6.38 has three I/O schedulers, namely noop, deadline and CFQ (Complete Fair Queuing). Noop scheduler performs bare minimum operations on I/O requests. New requests are submitted to the scheduler queue in FIFO fashion. Requests are dispatched from the scheduler queue in FIFO fashion only but it adds the request to the request queue in such a fashion that contiguous types of requests are in sorted order in dispatch queue. Noop scheduler performs best out of other traditional schedulers for SSD devices since it does very minimal operations but the read/write requests can be merged in a way which causes more writes to SSD. Since SSDs work better if the write requests come in sequential manner, noop scheduler only sorts requests if they are contiguous in type. For example, if a series of write requests come in such a manner that the first request belongs to first flash block, the second request to second block and so on, followed by one or more read request, followed by another series of write requests in the manner stated above, and the followed by one or more read request. Noop scheduler cannot sort the requests and send to first block all the requests belong to first block but it sends first group of write requests in sorted order then one read request then second group in sorted order and so on. Since sequential manner cannot be maintained here because of in between read requests, it may cause trimmed pages to scatter and more garbage collection needs to be done which increases WA.

Deadline scheduler does separate out read and write requests in different scheduler queues, assign some timeline to each request, gives priority to read requests and run requests in batches of 16. Deadline scheduler puts read requests in read queue, wait for more read requests to come until unplug happens or time expires, read requests will be sorted and dispatched to request queue. Since in SSD devices, read requests performance is independent of ordering and geometrical distance between requests, it adds to performance. In write requests, since after merging request can become large and can span across flash blocks, it may cause more writes at any point in time and garbage collection needs to do more job to erase flash block. Also, deadline scheduler sorts request in a way similar to noop where requests are sorted based on request position rather than in a single flash block which will cause trimmed pages to scatter in various flash blocks, more garbage collection needs to be done and increases WA.

CFQ places synchronous requests submitted by processes into a number of per-process queues and then allocates time-slices for each of the queues to access the disk. The length of the time slice and the number of requests a queue is allowed to submit depends on the 10 priority of the given process. Asynchronous requests for all processes are batched together in fewer queues, one per priority. Again, this scheduler considers seek time for read requests which may cause the requests at very far to process late. In SSD devices, read performance is independent of seek time so this adds to performance. Also, the sorting is done based on request sector position, cause more trimmed pages in various flash blocks, more garbage collection is required and increases WA.

The present disclosure is directed to an I/O scheduler optimized for solid-state drives. The I/O scheduler in accordance with the present disclosure bundles the write requests in such a form that the write requests in each bundle goes into one SSD block. Bundling the write requests in accordance with the present disclosure reduces write amplification and increases system performance. The I/O scheduler in accordance with the present disclosure also helps increasing the life of the SSDs.

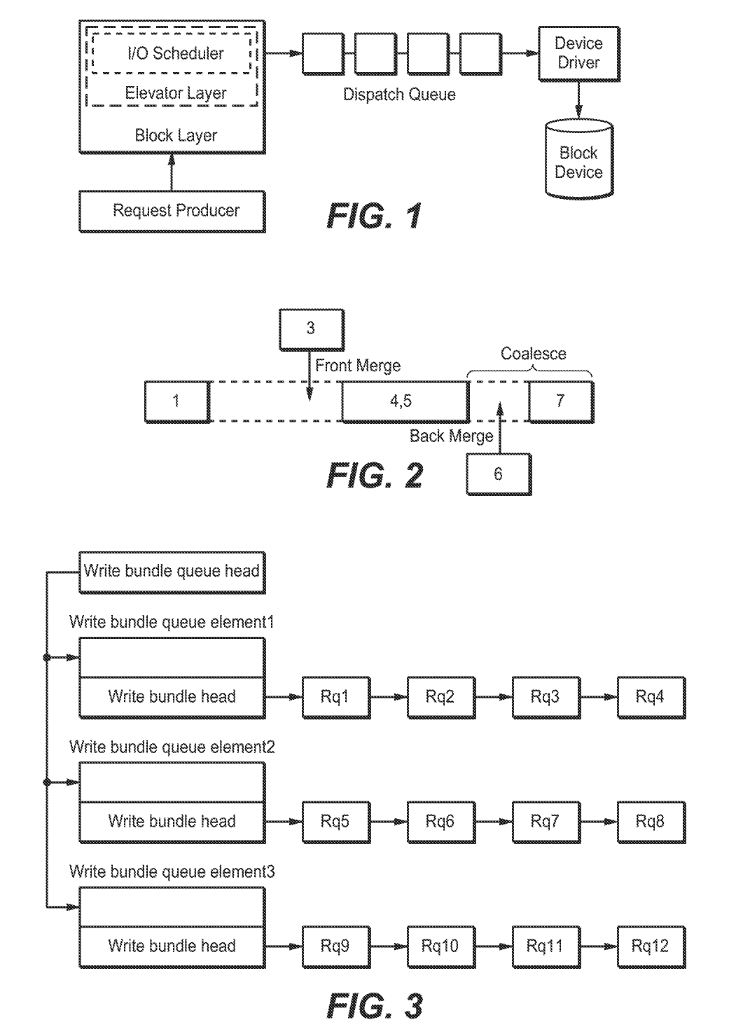

FIGS. 1 and 2 illustrate the general concept of I/O scheduling in a Linux system. FIG. 1 shows the Linux block I/O subsystem. As far as I/O scheduling is concerned, the key components are the elevator layer, the I/O scheduler itself, and the dispatch queue. The elevator layer connects the scheduler with the generic block I/O layer via an interface exported by the scheduler. It also provides basic functionality common to many I/O schedulers, such as merging and searching. The I/O scheduler is responsible for taking requests from the elevator layer, rearranging them according to some scheduling policy, and then populating the dispatch queue with requests which are consumed by the device driver and ultimately issued to the underlying device.

Two I/O requests are said to be logically adjacent when the end-sector of one request corresponds to the sector immediately before the start of the other. If these requests are in the same direction (that is, read or write), they can then be merged into a single larger request. When searching for merge opportunities while adding a new request, two types of merges are possible: front- and back-merges. A front-merge occurs when the new request falls before an existing adjacent request, according to start-sector order. When the new request falls after an existing request, a back-merge occurs. FIG. 2 shows merging graphically. For example, a request for sector 3 can be front-merged with an existing request for sectors 4 and 5, while the request for sector 6 can be back-merged with the same existing request. After an existing request has been involved in a merge, it is possible that the growth of the request causes it to become adjacent to another existing request. As with merging, these requests can then be coalesced into a single larger request. As depicted in FIG. 2, after back-merging request 6 with the existing request for sectors 4 and 5, the resulting request (now for sectors 4, 5 and 6) can be coalesced with request 7.

In the current Linux system, the Linux generic elevator layer maintains a hash table of requests indexed by end-sector number, which is used to discover back-merge opportunities with an ideally constant-time hash table lookup. No front-merging functionality is provided, so the functionality must be implemented by each I/O scheduler if desired. The elevator layer also provides a “one-hit” merge cache which stores the last request involved in a merge. This cache is checked for both front- and back-merge possibilities before performing a more general merge search. Requests involved in a merge are automatically coalesced using the elevator former request function and elevator latter request function functions which are provided by the I/O scheduler.

An objective of the I/O scheduler in accordance with the present disclosure is to reduce write amplification and improve performance. In one embodiment, the I/O scheduler may be optimized for random reads and sequential writes I/O patterns. If the I/O scheduler receives write requests in sequential order, no sorting is necessary. Otherwise, the I/O scheduler may sort the write requests accordingly. Read requests may be arranged in a binary search tree (e.g., a red-black, or RB tree) as well as in a queue (e.g., a FIFO queue). The I/O scheduler in accordance with the present disclosure improves write performances of the SSDs by issuing sequential write IOs each within an erasable boundary to reduce write amplification. The I/O scheduler also merges I/Os to reduce the number of requests in order to further improve the system performance.

SSD attributes are such that if writes are coming in sequential manner, trimmed pages are less scattered, less number of blocks needs to be erased so less number of extra writes is there, which reduces WA. Apart from that, writes which are coming aligned to flash block boundary (i.e. write requests that do not span across flash block boundaries) also reduce the number of extra writes, which reduces WA. Lowering WA allows the host I/O requests to finish faster and better latencies can be achieved. The design of the I/O scheduler in accordance with the present disclosure therefore considers these parameters of restricting write I/O requests to merge across flash block boundaries, dispatch write 10 requests that fall in the same flash block in sequential manner and dispatch read requests as it is because there is no seek time involved.

More specifically, to improve write performance of SSD devices, three points are taken into consideration: serial write I/O requests reduce WA, write I/O requests in a flash erase block boundary reduce WA, and merging of I/O requests cause less number of requests downstream. In accordance with the present disclosure, write requests are handled utilizing a queue of write bundles. Each write bundle may include one or more write requests. The size of each write bundle is less than or equal to the size of a flash erasable block of the SSD. For instance, if the size of the flash erasable block is 256 KB, the size of each write bundles is configured to be maximum 256 KB. In this manner, since the write request(s) within each write bundle happens within a flash erasable block, the number of extra writes is minimized (in case of garbage collection) and write amplification is reduced. In one embodiment, the write bundles may be filled in an insertion sort manner. Therefore, if the I/O scheduler receives sequential write requests, the write bundle(s) may be filled in constant time.

Read requests, on the other hand, are arranged in a RB tree to make front merging faster. A FIFO queue is also utilized to record the read requests. The FIFO queue may indicate whether the read requests are expired or not. During dispatch, if there are expired read requests in the FIFO queue, such requests may be dispatched. Otherwise, read requests may be dispatched from the RB tree.

Each request in the write queue and the read queue is assigned an expiration time (i.e., write_expire and read_expire). The expiration time may be measured in milliseconds, but it is contemplated that other time units may also be utilized. In one embodiment, the assigned expiration time for each request is a soft deadline. Priority may be given to read requests. That is, one write bundle from the write queue may be dispatched for N (e.g., 16) read requests dispatched. It is contemplated that the value of N may be configurable and may differ without departing from the spirit and scope of the present disclosure.

As previously mentioned, the size of each write bundle is less than or equal to the flash erasable block size, and all write requests in one bundle are for the same SSD block. For example, suppose there are three write requests R1, R2 and R3, wherein R1 writes to sector 0 through 16383, R2 writes to sector 32768 through 49151, and R3 writes to sector 262144 through 278527. Since R1 and R2 write to the same block, they belong to the same bundle. R3, on the other hand, writes to a different block and therefore belongs to another bundle.

As illustrated in FIG. 3, write bundles in accordance with the present disclosure are arranged in a write queue. Each write bundle contains requests which write to the same SSD block. It is contemplated that the write requests in each bundle may be sorted by sector numbers. For example, in FIG. 3, request 1 (rq1) is the request having the smallest sector number, and request 4 (rq4) has a smaller sector number compare to request 5 (rq5) and so on. It is also contemplated that while each bundle in FIG. 3 contains the same number of requests, such an illustration is merely exemplary, and that different write bundles in accordance with the present disclosure may contain different number of requests, as long as the size of each write bundle is less than or equal to the flash erasable block size, and all write requests in one bundle are for the same SSD block.

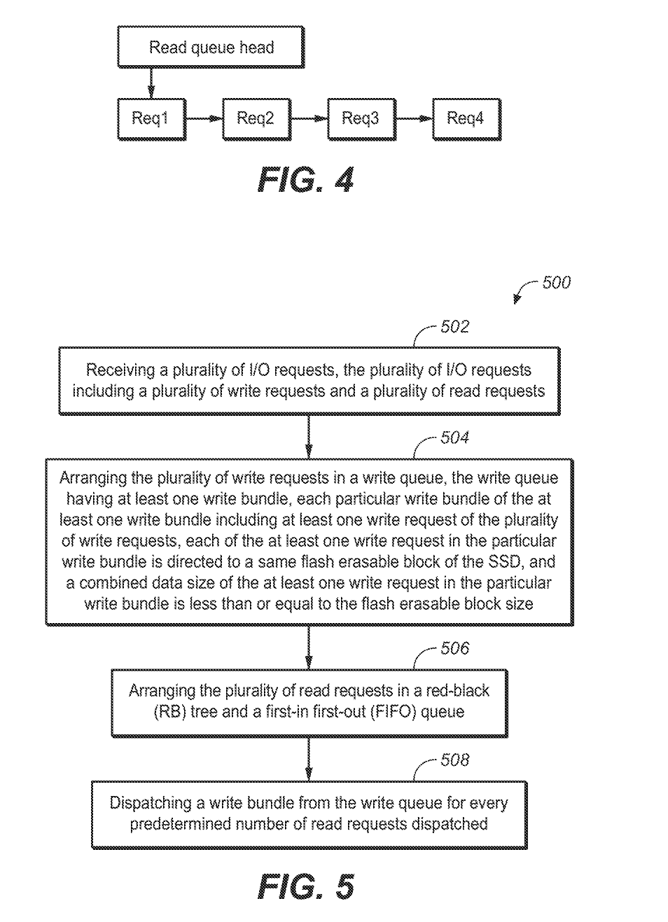

Different from the write requests, read requests are dispatched on the spot to the request queue by the I/O scheduler as they arrive. Since SSD devices do not have any seek time, there is no need to modify the order of the read requests, therefore reducing read latency. As illustrated in FIG. 4, read requests are placed in a FIFO queue to track request expirations. A new read request is inserted at the tail of the read queue if it cannot be merged. FIG. 4 depicts four of such read requests. The requests in the FIFO queue are sorted by timestamp. In addition, a RB tree is maintained for the read requests. Read requests are inserted into the proper location in the RB tree. RB tree is utilized for reducing the search time during front merging. As previously mentioned, during dispatch, if there are expired read requests in the FIFO queue, such requests will be dispatched. Otherwise, read requests will be dispatched from the RB tree.

It is contemplated that the I/O scheduler in accordance with the present disclosure may perform back merging via the sector sorted hash table provided by the elevator layer, along with optional front merging. Read requests may be merged and coalesced if possible by checking minimum conditions but write request merging will be constrained by the flash erasable block size. In accordance with the present disclosure, write request merging is not permissible across bundles (i.e., across flash erasable block boundaries) except when both write bundles are completely aligned at the flash erasable block boundary and are both the exact size of the flash erasable block. If both of these conditions are verified, write bundles may be merged accordingly. It is understood that merging of write bundles may reduce communication overhead and improve system performance.

It is also contemplated that certain parameters utilized by the I/O scheduler in accordance with the present disclosure may be configurable. For instance, a user may set/configure such parameters prior to and/or at run time. Such parameters may include, but not limited to, writes_starved, read_expire, write_expire, flash_block_size, front_merges and the like. For example, writes_starved may specify the number of read requests per write bundle dispatched (default value may be 16); read_expire may specify the read request expiration time (default value may be 125 milliseconds); write_expire may specify the write request expiration time (default value may be 250 milliseconds); flash_block_size may specify the size of an erasable block (default value may be 512 sectors); and front_merges may indicate whether front merge is enabled (may be enabled by default). It is understood that the list of configurable parameters and their default values are merely exemplary. Various other parameters may be user-configurable without departing from the spirit and scope of the present disclosure.

In one embodiment, memory may be allocated dynamically during initialization of the I/O scheduler. Free list of write bundle queue elements is allocated at initialization time. They may then be used statically to allocate and free the write bundle queue elements. Dynamic allocation of memory in the I/O path is may not be necessary in accordance with the present disclosure.

The timing complexity of the I/O scheduler in accordance with the present disclosure is comparable to existing Linux I/O schedulers. For instance, the complexity for adding a read request is O(log n) (i.e., the complexity for adding the read request to the RB tree; adding the read request to the FIFO queue is constant). Similarly, the complexity for dispatching a read request is also O(log n). In addition, the complexity for adding a write request is constant if write requests received by the I/O scheduler are sequential. Otherwise, the complexity for adding a write request is O(n²) because of the insertion sort. In either case (whether the received write requests are sequential or not), the complexity for dispatching a write bundle from the write queue is constant. Furthermore, if front merge is supported, read request addition is O(log n), write request addition is constant time if write requests received by the I/O scheduler are sequential, and otherwise O(n²) because of the insertion sort.

It is contemplated that if write requests received by the I/O scheduler are not sequential writes, a RB tree may be utilized for each write bundle in order to improve the performance. For example, if it is expected that the system utilizing the I/O scheduler is likely to issue sequential writes, the doubly linked list as illustrated in FIG. 3 may be utilized. On the other hand, if it is expected that the system utilizing the I/O scheduler is likely to issue random writes, then a RB tree may be utilized for each bundle instead of the linked list. It is understood, however, that other data structures may also be utilized for managing the read and write requests without departing from the spirit and scope of the present disclosure.

It is contemplated that aligning the write requests to flash erasable blocks and dispatch them in bundles as described above reduces write amplification and increases performance. Since each write bundle corresponds to one block, the FTL layer (of the Linux system) may allocate new pages to new writes and the previous pages would become trimmed. Furthermore, since the trimmed pages would be in one block, it would be easy for garbage collector to collect them at once. In addition, continuous write bundles that are completely aligned at the flash erasable block boundaries may be merged to form a merged request to improve performance. The size of the merged request formed in this manner may be multiple of flash erasable block size.

Furthermore, sequential writes (either as received or sorted by the I/O scheduler as described above) may cause almost full blocks to be trimmed, therefore garbage collection may simply erase full blocks rather than multiple partially trimmed blocks. Erasing partially trimmed blocks takes more time as the FTL layer has to re-write valid pages in a block to somewhere else and erase full block anyway. Therefore, the I/O scheduler in accordance with the present disclosure schedules and bundles the write requests in such a way that minimizes the amount of works required of the garbage collector. The garbage collector itself may be implemented utilizing any conventional garbage collection algorithm, and therefore the I/O scheduler in accordance with the present disclosure may be integrated into any Linux system without any compatibility concerns.

FIG. 5 shows a flow diagram illustrating the I/O scheduling method 500 in accordance with the present disclosure. Upon receiving a plurality of I/O requests in step 502, step 504 may arrange the write requests in a write queue as described above. More specifically, the write queue may include one or more write bundles. Each write bundle may include one or more write requests directed to the same flash erasable block of the SSD. Furthermore, the combined data size of the write requests in each write bundle is less than or equal to the flash erasable block size, as previously described.

Step 506 may arrange the read requests in a binary search tree (e.g., a RB tree) as well as in a FIFO queue. The FIFO queue of the read requests is configured for indicating an expiration time associated with each read request, and the read requests may be dispatched from the RB tree unless at least one read request is indicated as expired by the FIFO queue, in which case the read request would be dispatched from the FIFO queue instead. Step 508 may then dispatch a write bundle from the write queue for every predetermined number of read requests dispatched.

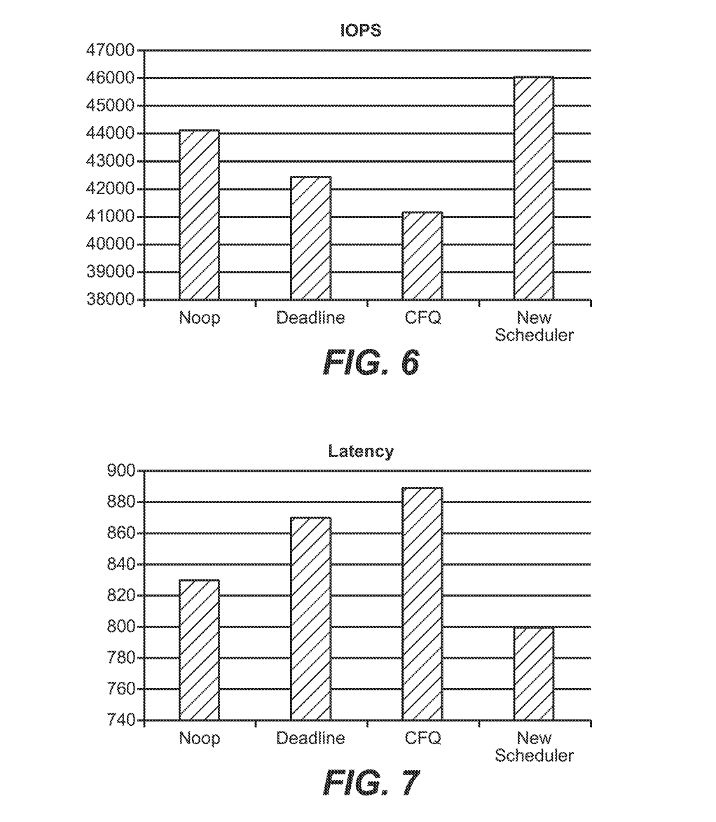

The benchmark testing results of the I/O scheduler in accordance with the present disclosure compared to the existing Linux I/O schedulers are shown in FIGS. 6 and 7. FIG. 6 shows the IOPS comparison between various schedulers, wherein the X axis is the name of the scheduler and the Y axis is the count of IOPS (I/O Operations Per Second). FIG. 7 shows the latency comparison between various schedulers, wherein the X axis is the name of the scheduler and the Y axis is the latency in microseconds. The benchmark testing indicates that the I/O scheduler in accordance with the present disclosure performs best out of all.

It is to be understood that the present disclosure may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for scheduling write requests to a solid-state drive (SSD), the method comprising:
receiving a plurality of write requests;
forming a write bundle, the write bundle including at least one write request of the plurality of write requests, each of the at least one write request in the write bundle is directed to a same flash erasable block of the SSD, and a combined data size of the at least one write request in the write bundle is less than or equal to the flash erasable block size; and
dispatching the write bundle to the SSD.

2. The method of claim 1, wherein write requests in the write bundle are stored in a linked list and are sorted based on sector numbers.

3. The method of claim 1, wherein write requests in the write bundle are stored in a red-black tree.

4. The method of claim 1, further comprising:
forming a second write bundle, the second write bundle including at least one write request of the plurality of write requests, each of the at least one write request in the second write bundle is directed to another flash erasable block of the SSD, and the combined data size of the at least one write request in the second write bundle is less than or equal to the flash erasable block size; and
dispatching the second write bundle to the SSD.

5. The method of claim 4, further comprising:
dispatching a predetermined number of read requests to the SSD between the dispatching of the first mentioned write bundle and the dispatching of the second write bundle.

6. The method of claim 4, further comprising:
determining whether to merge the first mentioned write bundle and the second write bundle;
merging the first mentioned write bundle and the second write bundle; and
dispatching the merged write bundle to the SSD.

7. The method of claim 4, wherein the first mentioned write bundle and the second write bundle are stored in a linked list.

8. A method for scheduling I/O requests to a solid-state drive (SSD), the method comprising:
receiving a plurality of I/O requests, the plurality of I/O requests including a plurality of write requests and a plurality of read requests;
arranging the plurality of write requests in a write queue, the write queue having at least one write bundle, each particular write bundle of the at least one write bundle including at least one write request of the plurality of write requests, each of the at least one write request in the particular write bundle is directed to a same flash erasable block of the SSD, and a combined data size of the at least one write request in the particular write bundle is equal to the flash erasable block size;
arranging the plurality of read requests in a red-black (RB) tree and a first-in first-out (FIFO) queue; and
dispatching a write bundle from the write queue for every predetermined number of read requests dispatched.

9. The method of claim 8, wherein the FIFO queue of the plurality of read requests is configured for indicating an expiration time associated with each read request.

10. The method of claim 9, wherein the read requests are dispatched from the RB tree unless at least one read request is indicated as expired by the FIFO queue of the plurality of read requests.

11. The method of claim 8, wherein write requests in each write bundle are stored in a linked list and are sorted based on sector numbers.

12. The method of claim 8, wherein write requests in each write bundle are stored in a red-black tree.

13. The method of claim 8, further comprising:
determining whether to merge two write bundles in the write queue; and
merging the two write bundles in the write queue for dispatching to the SSD in the same operation.

14. A computer-readable device having computer-executable instructions for performing a method for scheduling I/O requests to a solid-state drive (SSD), the method comprising:
receiving a plurality of I/O requests, the plurality of I/O requests including a plurality of write requests and a plurality of read requests;
arranging the plurality of write requests in a write queue, the write queue having at least one write bundle, each particular write bundle of the at least one write bundle including at least one write request of the plurality of write requests, each of the at least one write request in the particular write bundle is directed to a same flash erasable block of the SSD, and a combined data size of the at least one write request in the particular write bundle is equal to the flash erasable block size;
arranging the plurality of read requests in a red-black (RB) tree and a first-in first-out (FIFO) queue; and
dispatching a write bundle from the write queue for every predetermined number of read requests dispatched.

15. The computer-readable device of claim 14, wherein the FIFO queue of the plurality of read requests is configured for indicating an expiration time associated with each read request.

16. The computer-readable device of claim 15, wherein the read requests are dispatched from the RB tree unless at least one read request is indicated as expired by the FIFO queue of the plurality of read requests.

17. The computer-readable device of claim 14, wherein write requests in each write bundle are stored in a linked list and are sorted based on sector numbers.

18. The computer-readable device of claim 14, wherein write requests in each write bundle are stored in a red-black tree.

19. The computer-readable device of claim 14, wherein the method further comprising:
determining whether to merge two write bundles in the write queue; and
merging the two write bundles in the write queue for dispatching to the SSD in the same operation.

20. The computer-readable device of claim 14, wherein the method is configured for operating in with a Linux kernel.
